(19) United States
(12) Patent Application Publication
(10) Pub. No.: US 2009/0328103 A1
(43) Pub. Date: Dec. 31, 2009

(54) GENRE-BASED SEGMENT COLLECTIONS

(75) Inventor: Ronald A. Morris, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/145,899

(22) Filed: Jun. 25, 2008

(51) Int. Cl. G09G 3/06

(52) U.S. Cl. 725/44

(57) ABSTRACT

Genre-based segment collections is described. In embodiment(s), program segments that have been segmented from multiple television programs can be determined to have a common association based on a genre of the program segments. A segment collection can then be generated to include the program segments that have been determined to have the common association. The program segments of the segment collection can be selected from a collections user interface to initiate rendering the program segments for viewing.

### BACKGROUND

Viewers have an ever-increasing selection of media content to choose from, such as television programming, movies, videos, and music that is available for selection and viewing. Given the large volume of the various types of media content to choose from, viewers may want to be able to locate media content that is of interest to them from an organized and intuitive type of selection utility. Adding to the already large volume of available viewing options, a number of current television programs include a variety of subject matter within them, namely variety shows, talk shows, and entertainment programs that include a diverse range of topics, people, news stories, musical performances, and other content that may be of interest to a viewer.

It can be difficult for a person who is only interested in live musical performances, for example, to see only that portion of a program from the multitude of daytime talk shows, late night entertainment programs, and weekend variety shows. Typically, the only way to view several live musical performances from the variety of different shows and programs is to record them (if the viewer knows of the performance in advance), navigate to each recorded program, and then scan forward to the position of the performance in each of the programs.

### SUMMARY

This summary is provided to introduce simplified concepts of genre-based segment collections. The simplified concepts are further described below in the Detailed Description. This summary is not intended to identify essential features of the claimed subject matter, nor is it intended for use in determining the scope of the claimed subject matter.

Genre-based segment collections is described. In embodiment(s), program segments that have been segmented from multiple television programs can be determined to have a common association based on a genre of the program segments. A segment collection can then be generated to include the program segments that have been determined to have the common association. The program segments of the segment collection can be selected from a collections user interface to initiate rendering the program segments for viewing. In an embodiment, the program segments of a segment collection can be sequentially rendered for viewing without viewer selection or interaction after one of the program segments is initially selected for viewing.

In other embodiment(s), the multiple television programs from which the program segments have been segmented can be episodes of a television program series, and the program segments are each a similar segment from one of the television programs in the television program series. For example, the program segments can include the live musical performances from various musical guests that perform live each night on a particular late night entertainment talk show. Alternatively, the multiple television programs from which the program segments have been segmented can be episodes of different television programs, and the program segments are each a segment from one of the different television programs. For example, the program segments can include the live musical performances by a particular artist or music group that has performed live on several different late night entertainment talk shows.

In other embodiment(s), the multiple television programs can include news programs, where the program segments are each a news story from one of the news programs, and optionally, the program segments are determined to have a common association based on a topic of the news stories. Alternatively, the multiple television programs can include televised sporting events, where the program segments are each a sports play from one of the televised sporting events. Alternatively, or in addition, the program segments from an entertainment program, news program, sporting event, a movie, or any other genre of television programming can be determined to have a common association based on an event, a particular person, a geographic location, a musical group, or any other type of item or person that may be of interest to viewers when collected together for viewing in a segment collection.

### BRIEF DESCRIPTION OF THE DRAWINGS

Embodiments of genre-based segment collections are described with reference to the following drawings. The same numbers are used throughout the drawings to reference like features and components:

FIG. 1 illustrates an example system in which embodiments of genre-based segment collections can be implemented.

FIG. 2 illustrates another example system in which embodiments of genre-based segment collections can be implemented.

FIG. 3 illustrates example method(s) for genre-based segment collections in accordance with one or more embodiments.

FIG. 4 illustrates example method(s) for genre-based segment collections in accordance with one or more embodiments.

FIG. 5 illustrates various components of an example device that can implement embodiments of genre-based segment collections.

### DETAILED DESCRIPTION

Embodiments of genre-based segment collections provide that program segments from various and/or multiple television programs can be associated and grouped into a segment collection based on a genre of the program segments. For example, the multitude of daytime talk shows, late night entertainment programs, and weekend variety show may all be generally categorized as a “talk show”, which may not help a viewer who is interested in the live musical performances that these types of programs generally include during a segment of the program. A content distributor of television media content can include the program segments of just the live musical performances that are maintained as recorded media content, and that have been generated from the various talk shows described in this example. The program segments of the live musical performances can then be grouped into a segment collection from which a viewer can initiate a request to view any of the musical performances, or all of them sequentially.

In another example, many different television news sources offer news programs that are available for viewing which include many different news stories about nearly an unlimited number of topics. A viewer may want to watch, or be able to easily locate, news stories about a breaking news event. Program segments that include the news stories about the breaking news event from any number of the different television news sources can be grouped into a segment collection, and the viewer can view all of the news stories together without having to search and select from the various news channels. In other examples, a viewer may want to locate and watch program segments that include a particular person, such as a political candidate. Program segments that include the political candidate can be segmented from various programs, such as news programs, talk shows, and televised speeches, and then grouped into a segment collection. A viewer can then view all of the news stories, guest visits on a program, and speeches that pertain to the political candidate without having to search and browse through all of the possible sources of media content.

While features and concepts of the described systems and methods for genre-based segment collections can be implemented in any number of different environments, systems, and/or various configurations, embodiments of genre-based segment collections are described in the context of the following example systems and environments.

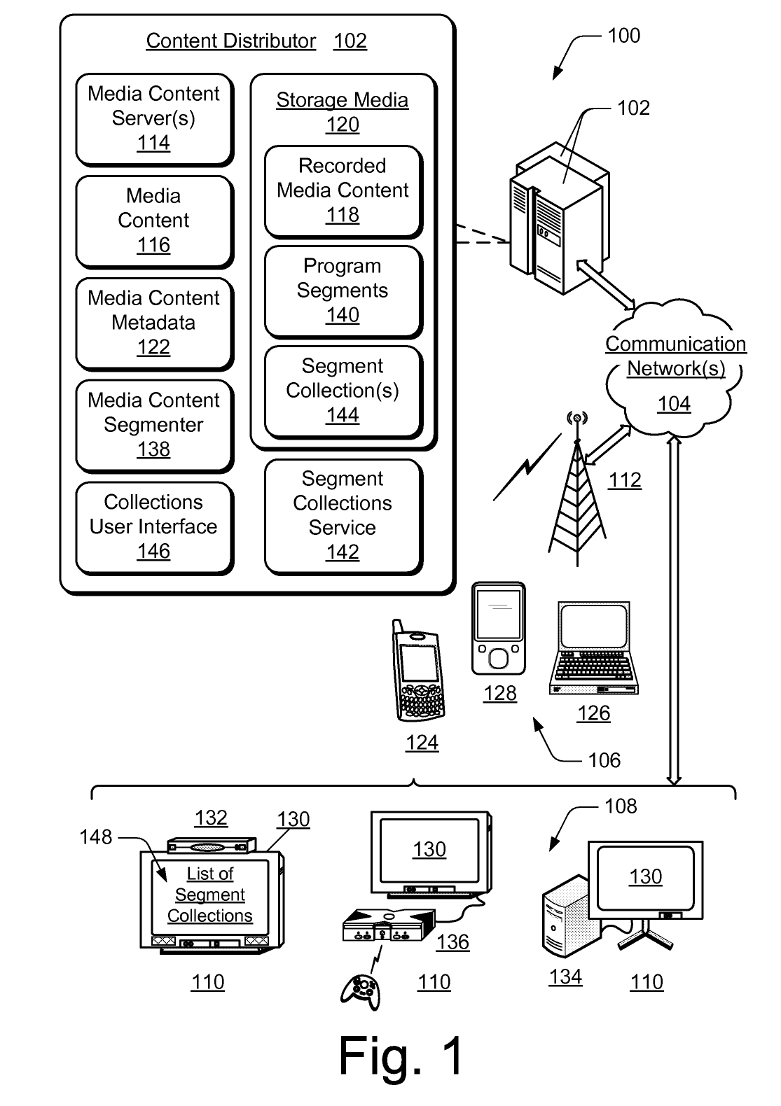

FIG. 1 illustrates an example system 100 in which various embodiments of genre-based segment collections can be implemented. In this example, system 100 includes one or more content distributors 102 that communicate or otherwise provide media content to any number of various media devices via communication network(s) 104. The various media devices can include wireless media devices 106 as well as other media devices 108 (e.g., wired and/or wireless client devices) that are implemented as components in various client systems 110. In a media content distribution system, the content distributors 102 facilitate the distribution of media content, content metadata, and/or other associated data to multiple viewers, users, customers, subscribers, viewing systems, and devices.

The communication network(s) 104 can be implemented to include any type of data network, voice network, broadcast network, an IP-based network, a wide area network (e.g., the Internet), and/or a wireless communications network 112 that facilitates media content distribution, as well as data and/or voice communications between the content distributors 102 and any number of the various media devices. The communication network(s) 104 can also be implemented using any type of network topology and/or communication protocol, and can be represented or otherwise implemented as a combination of two or more networks. Any one or more of the arrowed communication links facilitate two-way communications, such as from the content distributor 102 to a media device 108 (e.g., a client device) and vice-versa.

The content distributor 102 can include media content servers 114 that are implemented to receive television media content for distribution to subscriber media devices. The content distributor 102 can receive media content 116 from various content sources, such as a content provider, an advertiser, a national television distributor, and the like. The content distributor 102 can communicate or otherwise distribute media content 116 and/or other data to any number of the various wireless media devices 106 and other media devices 108.

The media content 116 (e.g., to include recorded media content 118) can include any type of audio, video, and/or image media content received from any type of media content source. As described throughout, “media content” can include television programs (or programming), advertisements, commercials, music, movies, video clips, and on-demand media content. Other media content can include interactive games, network-based applications, and any other audio, video, and/or image content (e.g., to include program guide application data, user interface data, advertising content, closed captions data, content metadata, search results and/or recommendations, and the like).

In the example system 100, the content distributor 102 includes storage media 120 to store or otherwise maintain various data and media content, such as media content 116, recorded media content 118, media content metadata 122, and/or subscriber information. In a Network Digital Video Recording (nDVR) implementation, recorded on-demand assets and media content can be recorded when initially distributed to the various media devices as scheduled television media content, and stored with the storage media 120 or other suitable storage device. The storage media 120 can be implemented as any type of memory, random access memory (RAM), read only memory (ROM), any type of magnetic or optical disk storage, and/or other suitable electronic data storage.

The media content metadata 122 can include any type of identifying criteria, descriptive information, and/or attributes associated with the media content 116 that can describe and categorize the media content. The metadata 122 that is associated with a television program, movie, or advertisement can be any form of information that describes and/or characterizes the media content. For example, metadata can include a program or movie identifier, a title, a subject description of the program, movie, or advertisement, a plot description, actor information, a date of production, broadcast channel, television network, artistic information, music compilations, and any other type of descriptive information about the media content. Further, the metadata can characterize a genre that describes the media content as being an advertisement, a movie, a comedy show, a sporting event, a news program, a sitcom, a talk show, an action/adventure program, or as any number of other category descriptions.

The wireless media devices 106 can include any type of device implemented to receive and/or communicate wireless data and voice communications, such as any one or combination of a mobile phone 124 (e.g., cellular, VoIP, WiFi, etc.), a portable computer device 126, a media device 128 (e.g., a personal media player, portable media player, etc.), and/or any other wireless media device that can receive media content in any form of audio, video, and/or image data. Each of the client systems 110 include a respective client device and display device 130 that together render or playback any form of audio, video, and/or image content, media content, and/or television content.

A display device 130 can be implemented as any type of a television, high definition television (HDTV), LCD, or similar display system. A client device in a client system 110 can be implemented as any one or combination of a television client device 132 (e.g., a television set-top box, a digital video recorder (DVR), etc.), a computer device 134, a gaming system 136, an appliance device, an electronic device, and/or as any other type of client device that can be implemented to receive television content or media content in any form of audio, video, and/or image data in a media content distribution system.

Any of the wireless media devices 106 and/or other media devices 108 can be implemented with one or more processors, communication components, memory components, signal processing and control circuits, and a media content rendering system. A media device may also be associated with a user or viewer (i.e., a person) and/or an entity that operates the device such that a media or client device describes logical devices that include users, software, and/or a combination of devices.

In this example, content distributor 102 includes a media content segmenter 138 (e.g., any type of media content or television program segmenting system) that is implemented to segment television programs (e.g., media content 116) into program segments 140 that are maintained as recorded media content 118 and individually viewable when requested. The content distributor 102 can also associate genre-based, media content metadata 122 with a particular program segment 140.

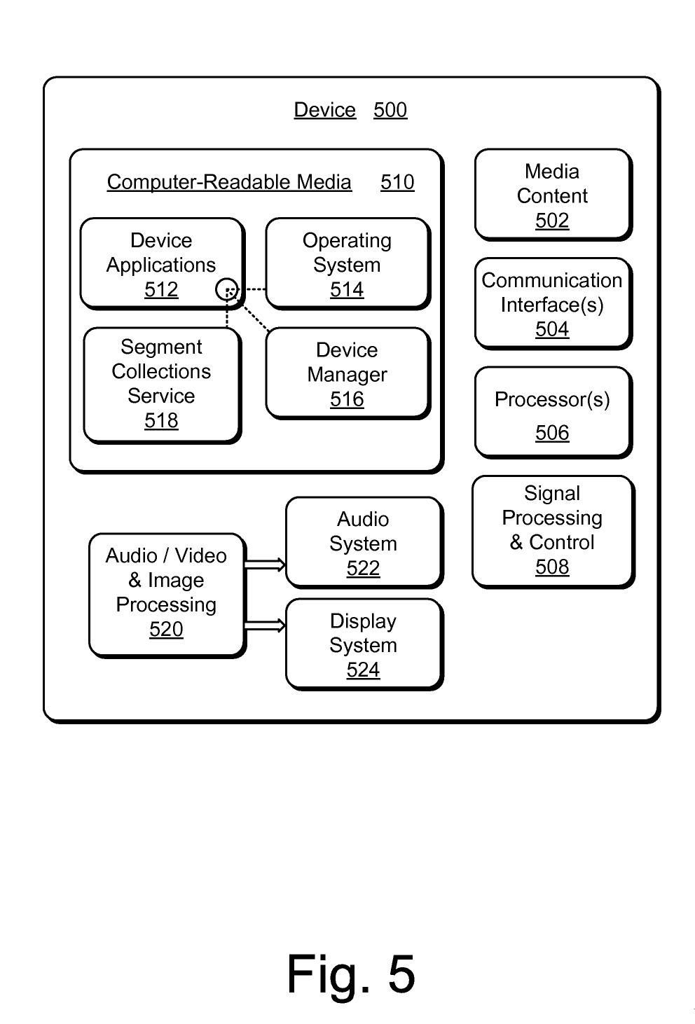

The content distributor 102 also includes a segment collections service 142 that can be implemented as computer-executable instructions and executed by processor(s) to implement the various embodiments of genre-based segment collections as described herein. Although illustrated and described as a component or module of content distributor 102, the segment collections service 142, as well as other functionality to implement the various embodiments described herein, can also be provided as a service apart from the content distributor 102 (e.g., on a separate server or by a third party service). In addition, a content distributor 102 can be implemented with any number and combination of differing components as further described with reference to the example device shown in FIG. 5.

In one or more embodiments, the segment collections service 142 can be implemented to determine the program segments 140 that have a common association based on a genre of the program segments. In an implementation, the genre of a program segment can be determined from media content metadata 122, closed-caption data, and/or other provided data that corresponds to a program segment 140. The segment collections service 142 can also be implemented to generate a segment collection 144 that includes the program segments 140 which are determined to have the common association. In this example, storage media 120 stores or otherwise maintains the program segments 140 and the segment collections 144 as they are generated and updated. In an implementation, a segment collection 144 can be maintained as a group of references to the program segments 140 that are included in the segment collection. In various embodiments, any of the program segments 140 may be included in one or several of the segment collections 144.

In an embodiment, the program segments 140 that are included in a segment collection 144 may have been segmented from episodes of the same television program series, and the program segments 140 are each a similar segment from one of the television programs in the series. For example, the program segments 140 in a segment collection 144 can include the live musical performances from various musical guests that perform live each night on a particular late night entertainment program. The program segments 140 that are included in the segment collection 144 all correspond to an entertainment segment in the late night entertainment program. Alternatively, the program segments 140 that are included in a segment collection 144 may have been segmented from episodes of different television programs, and the program segments 140 are each a segment from one of the different television programs. For example, the program segments 140 in a segment collection 144 can include the live musical performances by a particular artist or music group that has performed live on several different daytime talk shows, late night entertainment programs, and/or weekend variety shows.

In another embodiment, the program segments 140 that are included in a segment collection 144 may have been segmented from multiple television news programs. The program segments 140 may each include a news story from one of the news programs, and the program segments 140 can be determined to have a common association in the segment collection 144 based on a topic of the news stories. A viewer that wants to locate and watch news stories about a breaking news event from any number of different television news sources can view all of the news stories together from the segment collection 144 without having to search and select from the various news channels.

In another embodiment, the program segments 140 that are included in a segment collection 144 may have been segmented from televised sporting events. The program segments 140 may each include a sports play from one of the televised sporting events, and the program segments 140 can be determined to have a common association in the segment collection 144 based on an activity (e.g., a touchdown) and/or based on a person (e.g., a particular quarterback of a football team). A viewer that wants to locate and watch the touchdowns thrown by a particular quarterback during a football season can view all of the plays together from the segment collection 144.

In another embodiment, the program segments 140 that are included in a segment collection 144 can be determined to have a common association based on a person that is included in each of the program segments. For example, the program segments 140 can all be related to a political candidate and may have been segmented from various programs, such as news programs, talk shows, and televised speeches given by the political candidate. A viewer can then view all of the news stories, guest visits on a program, and speeches that pertain to the political candidate without having to search and browse through all of the possible sources of media content.

In this example, the content distributor 102 also includes a collections user interface 146 which can be implemented as an interface to the segment collections 144 that can be accessed via a media device, such as television client device 132. A media device can include a user interface application to display a list of segment collections 148 on a display device 130. A segment collection 144 can be selected from the list of segment collections 148, and the program segments 140 of the segment collection 144 are then selectable by a viewer at the television client device 132 to initiate rendering the program segments for viewing. From the previously described examples, the list of segment collections 148 can include a segment collection of live musical performances on various television programs; a segment collection of live musical performances by a particular artist or guest music group on various television programs; a segment collection of live musical performances by various artists on several episodes of one particular television program; a segment collection of news stories that are associated based on a topic of the news stories; a segment collection of sports plays from televised sporting events that include a particular type of sports play and/or include a particular player; and a segment collection of appearances by a particular person, such as a political candidate, leader of a country, sports figure, author, or any other type of person that may appear on various news, sports, and/or talk programs.

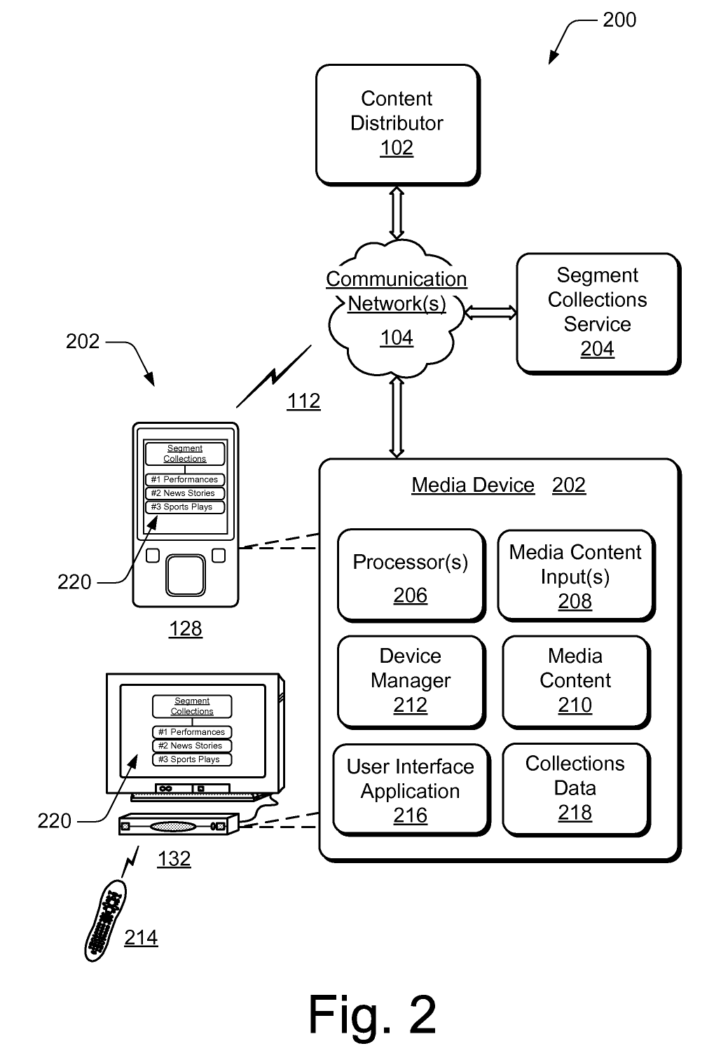

FIG. 2 illustrates an example system 200 in which various embodiments of genre-based segment collections can be implemented. In this example, system 200 includes the content distributor 102 and examples of wired and/or wireless media devices 202, such as portable media device 128 and television client device 132 as described with reference to FIG. 1. System 200 also includes an example of a segment collections service 204 that can be implemented as an independent component of system 200, and which implements the various embodiments of genre-based segment collections as described herein. The content distributor 102, media devices 202, and the segment collections service 204 can all be implemented for communication with each other via the communication network(s) 104 and/or the wireless communications network 112.

In this example, the segment collections service 204 is independent and implemented apart from content distributor 102 (e.g., on a separate server or by a third party service), and in an embodiment, can be implemented as a subscription-based service. Alternatively, the segment collections service 204 can be implemented as a component or service of the content distributor 102 as described with reference to FIG. 1.

The media devices 202 can be implemented with processing, communication, and memory components, as well as signal processing and control circuits. A media device 202 may also be associated with a user or owner (i.e., a person) and/or an entity that operates the device such that a media device describes logical devices that include users, software, and/or a combination of devices. In this example, the media device 202 includes one or more processors 206 (e.g., any of microprocessors, controllers, and the like), media content inputs 208, and media content 210 (e.g., received media content, media content that is being received, recommended media content, recorded media content, etc.). The media content inputs 208 can include any type of wireless, broadcast, and/or over-the-air inputs via which media content is received.

Media device 202 can also include a device manager 212 (e.g., a control application, software application, signal processing and control module, etc.) that can be implemented as computer-executable instructions and executed by the processors 206 to implement various embodiments and/or features of genre-based segment collections as described herein. The device manager 212 can be implemented to monitor and/or receive selectable inputs (e.g., viewer selections, navigation inputs, etc.) via an input device 214, and initiate communication of viewer selections back to content distributor 102 and/or to the segment collections service 204.

Media device 202 can also include a user interface application 216 that can be implemented as computer-executable instructions and executed by the processors 206 to implement various embodiments and/or features of genre-based segment collections as described herein. For example, the user interface application 216 can process collections data 218 that is received from content distributor 102 and/or from the segment collections service 204, and from which a list of segment collections 220 can be rendered and/or displayed for viewing at a media device 202. A media device 202 can display the various types of media content 210, as well as the list of segment collections 220 and/or program segments of a segment collection.

A viewer can interact with a media device 202 and initiate viewer navigation inputs and selections of a segment collection and/or program segments from the list of segment collections 220 with user inputs, such as on the portable media device 128 or with the remote control input device 214. For example, the list of segment collections 220 can be selected with remote control inputs to scroll the list of segment collections up and/or down to display and select the various collections of program segments.

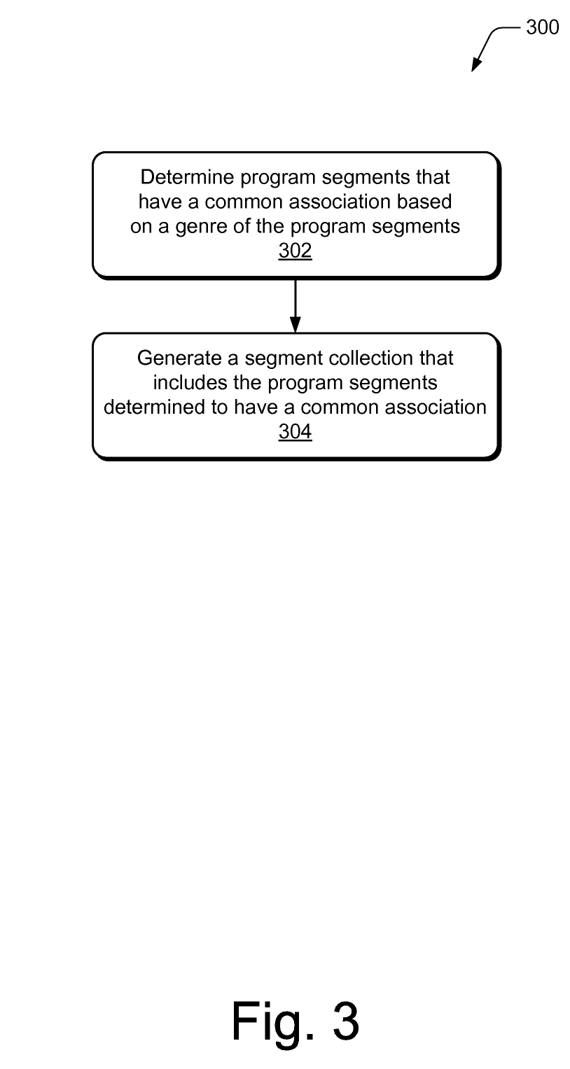

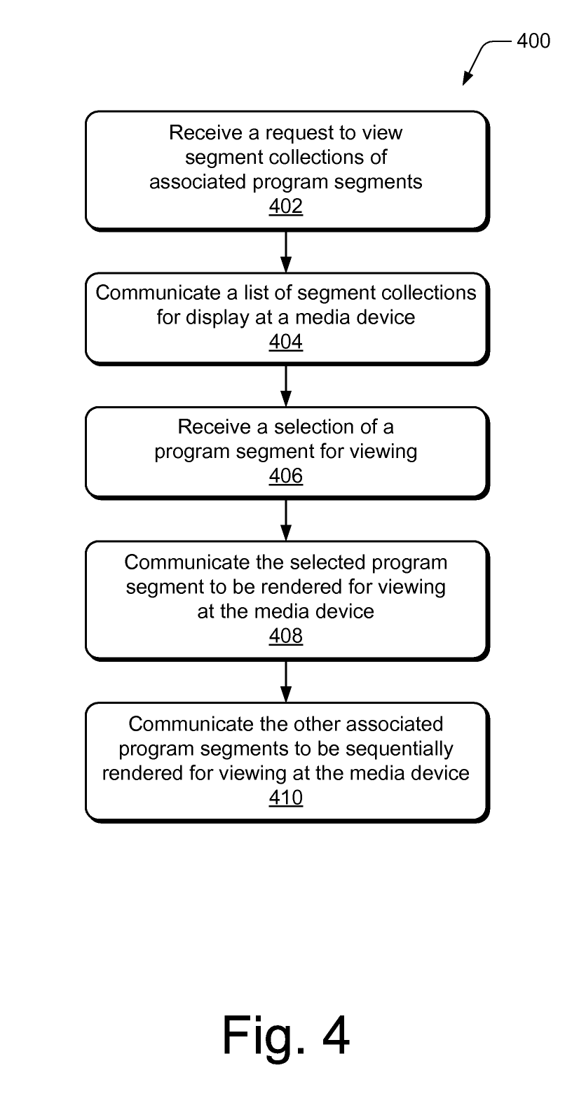

Example methods 300 and 400 are described with reference to respective FIGS. 3 and 4 in accordance with one or more embodiments of genre-based segment collections. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. Example methods 300 and 400 may be described in the general context of computer-executable instructions. Generally, computer-executable instructions can include software, applications, routines, programs, objects, components, data structures, procedures, modules, functions, and the like.

The method(s) may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of genre-based segment collections, and is described with reference to a content distributor and/or a segment collections service. The order in which the method is described is not intended to be construed as a limitation, and any number of the described method blocks can be combined in any order to implement the method, or an alternate method.

At block 302, program segments are determined that have a common association based on a genre of the program segments. For example, the segment collections service 142 at content distributor 102 (FIG. 1) determines the program segments 140 that have a common association based on a genre of the program segments. The genre of a program segment can also be determined from media content metadata 122, closed-caption data, and/or other provided data that corresponds to a program segment 140.

The program segments 140 that are included in a segment collection 144 can be segmented from multiple television programs (e.g., media content 116). For example, the television programs can be episodes of a television program series, and the program segments 140 are each a similar segment from one of the television programs in the television program series. In another example, the television programs can be episodes of different television programs, and the program segments 140 are each a segment from one of the different television programs. In another example, the television programs can be news programs, and the program segments 140 are each a news story from one of the news programs and are determined to have a common association based on a topic of the news stories. In another example, the television programs can be televised sporting events, and the program segments 140 are each a sports play from one of the televised sporting events.

The program segments 140 of a segment collection 144 can also be determined to have a common association based on an entertainment segment in each of the television programs; based on a musical performance in each of the television programs; based on a person that is included in each of the program segments of the television programs; and/or based on any other common association as described herein. For example, the program segments from an entertainment program, news program, sporting event, a movie, or any other genre of television programming can be determined to have a common association based on an event, a particular person, a geographic location, a musical group, or any other type of item or person that may be of interest to viewers when collected together for viewing in a segment collection.

At block 304, a segment collection is generated that includes the program segments determined to have a common association. For example, the segment collections service 142 at content distributor 102 generates a segment collection 144 that includes the program segments 140 which are determined to have a common association. The program segments 140 of a segment collection 144 are selectable from a collections user interface 146 to initiate rendering a program segment for viewing. In addition, the program segments 140 that are included in a segment collection 144 can be sequentially rendered for viewing without viewer selection after the first program segment is selected for viewing. The program segments 140 are grouped into the segment collection 144 from which a viewer can initiate a request to view any one of the program segments, or all of them sequentially.

FIG. 4 illustrates example method(s) 400 of genre-based segment collections, and is described with reference to a content distributor and/or a segment collections service. The order in which the method is described is not intended to be construed as a limitation, and any number of the described method blocks can be combined in any order to implement the method, or an alternate method.

At block 402, a request to view segment collections of associated program segments is received. For example, the segment collections service 142 at content distributor 102 (FIG. 1) receives a request from a television client device 132 for the segment collections 144. At block 404, a list of segment collections is communicated for display at a media device. For example, the segment collections service 142 initiates communication of the segment collections 144 to the television client device 132 that displays the list of segment collections 148 as a user interface on display device 130.

At block 406, selection of a program segment is received for viewing. For example, the segment collections service 142 receives a viewer-initiated selection of a program segment 140 that is included in a segment collection 144. The program segments 140 are grouped into the segment collection 144 from which a viewer can initiate a request to view any one of the program segments, or all of them sequentially.

At block 408, the selected program segment is communicated to be rendered for viewing at the media device. For example, the segment collections service 142 initiates communication of the selected program segment 140 to the television client device 132 that renders the program segment for viewing as a video clip. At block 410, the other associated program segments are communicated to the media device to be sequentially rendered for viewing. For example, the segment collections service 142 initiates communication of the other associated program segments 140 in a segment collection 144 to the television client device 132 that sequentially renders the program segments for viewing.

FIG. 5 illustrates various components of an example device 500 that can be implemented as any form of a mobile communication, computing, electronic, and/or media device to implement various embodiments of genre-based segment collections. For example, device 500 can be implemented as a computer device, server device, television client device, an independent segment collections service, and/or a content distributor as shown in FIG. 1 and/or FIG. 2.

Device 500 includes media content 502 and one or more communication interfaces 504 that can be implemented for any type of data and/or voice communication via communication network(s). Device 500 also includes one or more processors 506 (e.g., any of microprocessors, controllers, and the like) which process various computer-executable instructions to control the operation of device 500, and to implement embodiments of genre-based segment collections. Alternatively or in addition, device 500 can be implemented with any one or combination of hardware, firmware, or fixed logic circuitry that is implemented in connection with signal processing and control circuits which are generally identified at 508.

Device 500 also includes computer-readable media 510, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like.

Computer-readable media 510 provides data storage mechanisms to store the media content 502, as well as various device applications 512 and any other types of information and/or data related to operational aspects of device 500. For example, an operating system 514 can be maintained as a computer application with the computer-readable media 510 and executed on the processors 506. The device applications 512 can also include a device manager 516 and a segment collections service 518. In this example, the device applications 512 are shown as software modules and/or computer applications that can implement various embodiments of genre-based segment collections as described herein.

Device 500 can also include an audio, video, and/or image processing system 520 that provides audio data to an audio rendering system 522 and/or provides video or image data to an external or integrated display system 524. The audio rendering system 522 and/or the display system 524 can include any devices or components that process, display, and/or otherwise render audio, video, and image data. In an implementation, the audio rendering system 522 and/or the display system 524 can be implemented as integrated components of the example device 500. Although not shown, device 500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Although embodiments of genre-based segment collections have been described in language specific to features and/or methods, it is to be understood that the subject of the appended claims is not necessarily limited to the specific features or methods described. Rather, the specific features and methods are disclosed as example implementations of genre-based segment collections.

1. A method, comprising:
determining program segments that have a common association based on a genre of the program segments, the program segments having been segmented from multiple television programs; and
generating a segment collection that includes the program segments determined to have the common association.

2. A method as recited in claim 1, wherein the multiple television programs are episodes of a television program series, and the program segments are each a similar segment from one of the television programs in the television program series.

3. A method as recited in claim 1, wherein the multiple television programs include episodes of different television programs, and the program segments are each a segment from one of the different television programs.

4. A method as recited in claim 1, wherein the multiple television programs include news programs, the program segments are each a news story from one of the news programs, and the program segments are further determined to have the common association based on a topic of the news stories.

5. A method as recited in claim 1, wherein the multiple television programs include televised sporting events, and the program segments are each a sports play from one of the televised sporting events.

6. A method as recited in claim 1, wherein the program segments are further determined to have the common association based on an entertainment segment in each of the multiple television programs.

7. A method as recited in claim 1, wherein the program segments are further determined to have the common association based on a musical performance in each of the multiple television programs.

8. A method as recited in claim 1, wherein the program segments are further determined to have the common association based on a person that is included in each of the program segments of the multiple television programs.

9. A method as recited in claim 1, wherein the program segments of the segment collection are selectable from a collections user interface to initiate rendering a program segment for viewing.

10. A method as recited in claim 9, wherein the program segments are sequentially rendered for viewing without viewer selection after the program segment is selected from the collections user interface to initiate rendering the program segment for viewing.

11. A segment collections system, comprising:
a collections user interface configured to display a segment collection of program segments that have a common association, the program segments having been segmented from multiple television programs; and
a segment collections service configured to determine the program segments that have the common association based on a genre of the program segments, and further configured to generate the segment collection to include the program segments that are determined to have the common association.

12. A segment collections system as recited in claim 11, wherein the multiple television programs are episodes of a television program series, and the program segments are each a similar segment from one of the television programs in the television program series.

13. A segment collections system as recited in claim 11, wherein the multiple television programs include episodes of different television programs, and the program segments are each a segment from one of the different television programs.

14. A segment collections system as recited in claim 11, wherein the multiple television programs include news programs, the program segments are each a news story from one of the news programs, and the program segments are further determined to have the common association based on a topic of the news stories.

15. A segment collections system as recited in claim 11, wherein the multiple television programs include televised sporting events, and the program segments are each a sports play from one of the televised sporting events.

16. A segment collections system as recited in claim 11, wherein the program segments are further determined to have the common association based on an entertainment segment in each of the multiple television programs.

17. A segment collections system as recited in claim 11, wherein the program segments are further determined to have the common association based on a musical performance in each of the multiple television programs.

18. A segment collections system as recited in claim 11, wherein the program segments are further determined to have the common association based on a person that is included in each of the program segments of the multiple television programs.

19. A segment collections system as recited in claim 11, wherein the program segments of the segment collection are selectable from the collections user interface to initiate rendering the program segments for viewing.

20. One or more computer-readable media comprising computer-executable instructions that, when executed, implement a segment collections service to:
determine program segments that have a common association based on a genre of the program segments, the program segments having been segmented from multiple television programs; and
generate a segment collection that includes the program segments determined to have the common association.
